(19) United States
(12) Patent Application Publication
(10) Pub. No.: US 2005/0224199 A1
(43) Pub. Date: Oct. 13, 2005

(54) Bar screen device

(76) Inventor: Thomas Mickelat, NITTENAU (DE)

Correspondence Address: HENRY M FEIEREISEN, LLC, 350 FIFTH AVENUE, SUITE 4714, NEW YORK, NY, 10118, US

(21) Appl. No.: 10/512,230

(22) PCT Filed: Apr. 23, 2003
(86) PCT No.: PCT/EP03/04220

§ 371 Date: Oct. 22, 2004

(30) Foreign Application Priority Data
Apr. 24, 2002 (DE) 102 18 323.6

(51) Int. Cl. D21C 9/08; B07B 1/46

(52) U.S. Cl. 162/55; 209/408

(57) ABSTRACT

The invention relates to a bar screen device (1, 1′, 1″), especially for treating fibrous suspensions in the paper industry. Said device comprises a plurality of bars (2, 2′, 2″, 2″) which are fixed to at least one reinforcing element (3, 3′, 3″, 3″) in such a way that they extend parallel at a pre-determined mutual distance which is defined by spacer elements (4*, 4*′, 4*″, 4*″), the mutual distance between the same defining the width of the slits in the bar screen device. The spacer elements (4*, 4*′, 4*″, 4*″) are also embodied as connecting elements (4, 4′, 4″, 4″), especially in order to avoid notch-induced resistance variations, and fix the bars (2, 2′, 2″, 2″) to the reinforcing elements (3, 3′, 3″, 3″) in such a way that they are distanced, in all three dimensions, in a positively and force locking manner, from the base of the bars to as close as possible to the neutral fibres of the bars (2, 2′; 2″, 2″) impinged upon. In this way, the bars can be fixed to the reinforcing elements without welding, and the separated, spatially positively locking connections between the bars (2, 2′, 2″, 2″) and the combined spacer and connecting elements (4*, 4*′, 4*″, 4*″), and between the combined spacer and connecting elements (4, 4′, 4″, 4″) and the reinforcing elements (3, 3′, 3″, 3″), are largely free of any notch effect, such that the component resistance remains unlimited.

The invention refers to a slotted hole screening device, in particular for use in the treatment of fiber suspensions used in the paper industry and which includes the features as set forth in the preamble in claim 1.

In the prior German patent application 100 52 715.9 of Oct. 24, 2000 and not pre-published, a plug-in type slotted hole screen assembly is proposed which comprises at least one reinforcement element and where a plurality of rods are fixed in parallel disposition at pre-determined spaced distances by means of spacer elements. The spaced distance of these rods determines the slotted hole screen assembly. The rods in this plug-in type of slotted screen together with the reinforcement element, which for example, is configured as a reinforcement ring or fixating ring or with the spacer element forms a positive connection. The spacer elements can also be designed as single separate elements or, they can be collectively designed as a unitary spacer comb.

It has been shown that in this slotted hole screen assembly the direct, positive and non-positive connection of the rods with the reinforcement elements is associated with a reduced lifespan of the screening device due to the jags that are induced at the rods. In addition, the necessarily tightly matched tolerances of the rods with the reinforcement elements require a higher cost of manufacturing and assembly. It has been shown that with this type of slotted screen assembly that the direct form-fitting and force-fitting connection of the rods with the reinforcing elements or the spacer elements can negatively impact the life span of the slotted screen assembly due to the induced jagging effects on the rods. The tightly matching tolerances of the rods and the reinforcement elements thus require an additional expenditure in manufacturing and assembly.

Form EP 0 929 714 B1 a slotted hole screening device is known wherein the parallel profile rods are embedded in slotted U-shaped reinforcement rings and are positively attached at their lower end by means of a local deformation in the reinforcement ring. The plastic deformation produces a jag and reduces the capacity and/or the life of the profile rods.

From EP 0 417 408 B1 a slotted holed screen device is known which comprises profile rods having reinforcement rings with groove shaped recesses. The bottom of the groove is wider in order to fit the cross section of the complementary profile wire bottom in both a positive and non-positive manner. Accordingly, a profile wire bottom, viewed in cross section, must be formed which is wider with respect to the entire length of the profile wire, which leads to flow-mechanically unfavorable conditions.

In EP 0 499 154 B1 a screening device is described comprising the base elements, namely, profile rods and reinforcing rings. The profile wires are positively connected with the reinforcement rings by means of a snap-closure. The groove shaped recesses likewise induce indentation effect in the reinforcing rings leading to component fatigue.

Object of the invention is to overcome these afore-stated drawbacks of the prior art, and to provide a slotted hole screening device where the connection between the rods and the reinforcement rings are carried out substantially without a jag-producing weakening and which can be produced in a flexible and cost-efficient manner.

In accordance with the invention, a slotted hole screening device is provided having features as set forth in patent claim 1.

Further advantageous embodiments are set forth in claims 2 to 11.

In the slotted screening device according to the invention, a spacer element is provided having an integrated connecting element, which substantially fulfills three different objects. First, the connecting element is utilized for adjustment of the predetermined slot width of the slotted screening device, wherein the connecting element rests flatly on each of the rod bottom flanks facing the connecting element and thus are spaced relative to each other at a predetermined distance. Furthermore, the presence of the connecting element raises the stability of the rod, in that a positive connection as close as possible to the neutral fiber of the bending-stressed rod (loaded) is realized. In that manner, the bearing reaction is not placed into the zone of the highest stress, that is, either in the head of the rod or the bottom of the rod—but shifted into a zone of the rod which is less prone to stress. Thirdly, the connecting element forms a positive and non-positive snap connection between the combined spacer and connecting element and the reinforcing element, so that the reinforcing element will not exhibit any weakening jags in transverse direction and to minimize a premature collapse of that component. In addition, this ensures a flexible and cost efficient production.

In accordance with a further embodiment of the invention, the connecting elements that are positively linked with the rods form a positive connection with the reinforcement elements. This type of connection ensures a simple and cost-efficient assembly. By configuring the seat of the connecting elements always the same way, the need of a bearing support for reinforcement elements having different dimensions is reduced.

Preferably, for the formation of the positive connection, an annular-shaped recess or a tenon-shaped protrusion is provided at least on a front surface facing the rod. In both cases, they are facing the rod bottom flanks and may comprise symmetrical, such as for example a cylinder, an ellipses as well as asymmetrical shapes of recesses or protrusions. The same applies to complementary shaped recesses or protrusions in the rod bottom flanks. Due to pressing the protrusion and a complementary recess, a positive connection is being formed, which is able to absorb forces from all three dimensions.

In order to maintain an as low as possible flow resistance in the slotted hole screening device and in order to avoid retention of fiber during operation, the side of the connecting element facing the fiber suspension is configured in a flow-enhancing manner, for example it is respectively rounded.

Furthermore, the surfaces of the connecting element facing the reinforcement element are progressively adapted to the contour of the reinforcement element.

In accordance with a further embodiment, the slotted hole screening device is configured as a slotted hole screen cylinder or a slotted hole screen basket and the reinforcing element is configured as a reinforcing ring for absorbing the radial stresses. Thus, the connecting element according to the invention in co-operation with the rod bottom width reliably determines width of the slot or slit in such a slotted hole screen cylinder and the force of the bearing pressure reaction happens close to the neutral fiber of the rods.

In a simplification of production and reduction of assembly parts, several connecting elements can be bundled in the form of a continuous connecting element chain, which itself can comprise also one or more connecting element segments.

The connecting elements may be attached in larger spacing on a thin connection wire by means of a joint welding process, for example, resistance welding, in order to reduce the overall number of small parts and to exclude a source for error when incorporating single connecting elements having different thicknesses. Also, when segmenting the chain, a suitable chain length for assembly is realized.

Preferably, the reinforcement elements can be pre-fabricated as rings and additionally secured by means of a positive connection through a snap closure. This allows a higher operational security when joining and mounting the reinforcement rings and results also in a bigger fully-automated production yield.

In an alternative embodiment of a slotted hole screening device according to the invention, the positive connection of combined spacer and connecting element and rod will be formed in situ, whereby co-operating complementary parts at the rod and at the combined spacer- and connecting element are impressed directly at the site through bending.

In summary, it is essential when laying-out the slotted screening device according to the invention that the rods can be positively secured in three dimensions without limitation. This is essentially realized when the positive connection between the rods and the connecting elements combined with the spacer elements is disposed in close proximity to the neutral fiber of each of the bending-stressed rods. Furthermore, the positive connection of the rod and the combination spacer/connecting element will be separated from the positive connection of the rod with the reinforcing element whereby both are advantageously configured so as to make them as less prone to jagging impact as possible. In this manner, the slotted screen device according to the invention is produced in a cost efficient manner and without material-union of the connecting elements and the rods, and to thereby avoid that joining welding stress impacts upon the assembly components.

Preferred embodiments of the invention will be described hereinafter with reference to the appended drawings. It is shown in:

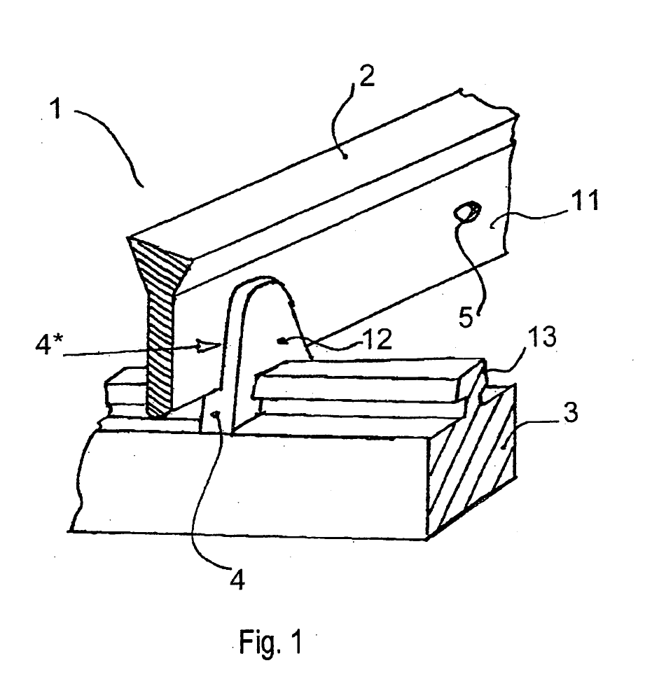

FIG. 1 a perspective partial view for illustration of essential components of a first preferred embodiment of a screening device according to the invention;

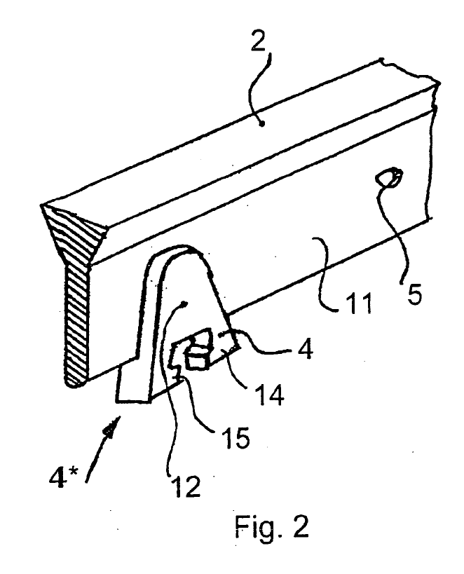

FIG. 2 a perspective partial view of the screening device according to FIG. 1 without reinforcing element.

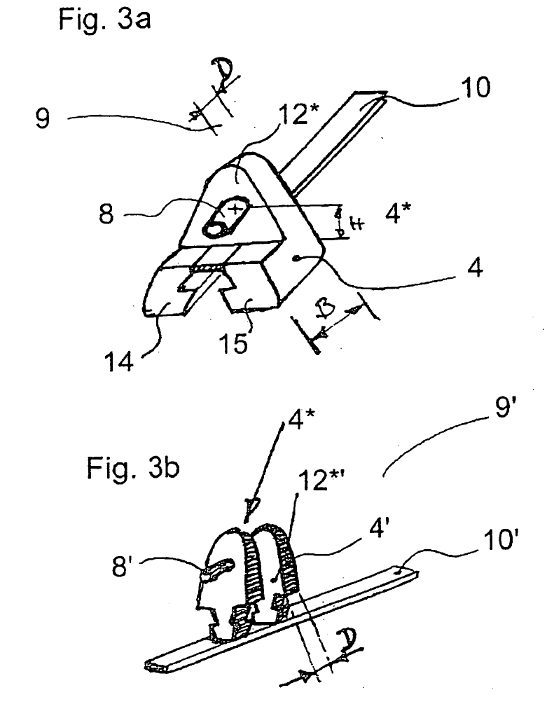

FIG. 3a and FIG. 3b respective illustrations of a single component of examples of connecting elements,

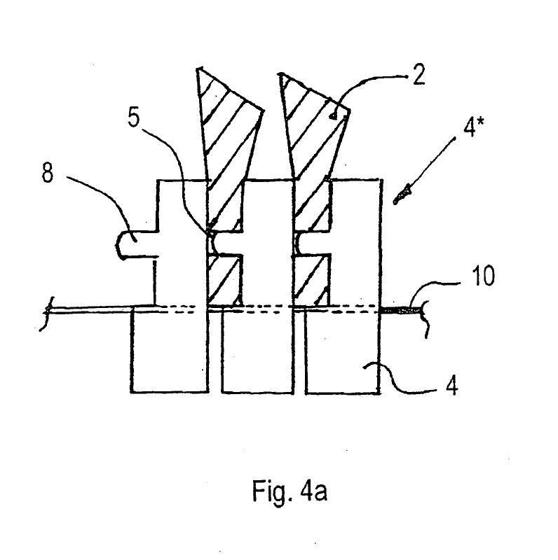

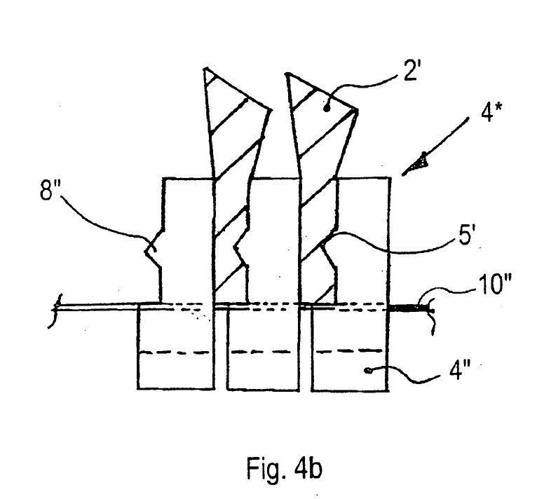

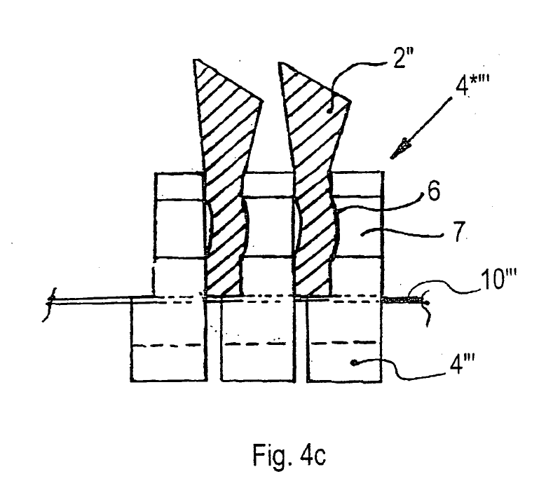

FIG. 4a to FIG. 4c, respective embodiments showing a schematic cross sectional view of assembly illustrations of a form-fitting connection between connecting element and rod;

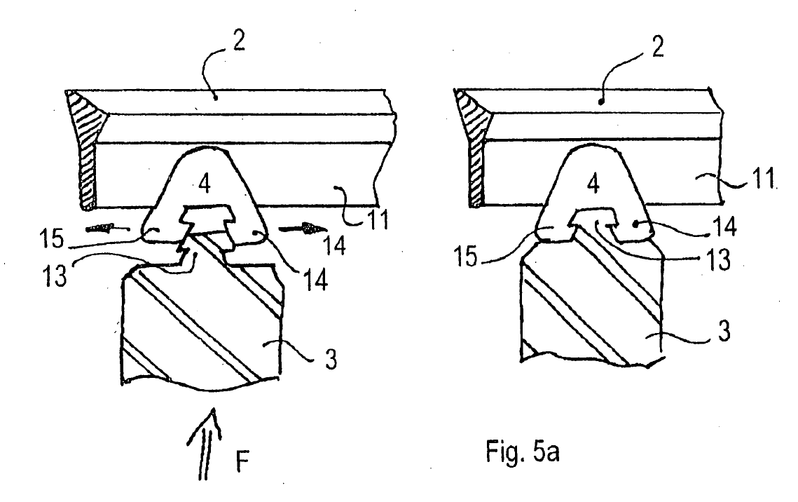

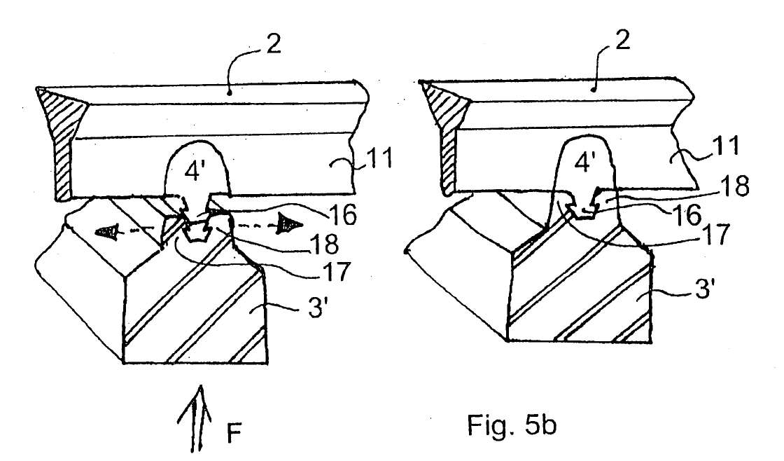

FIG. 5a and FIG. 5b, respective embodiments showing a schematic cross-sectional view of assembly illustrations of a form-fitting connection between connecting element and rods as well as reinforcing element;

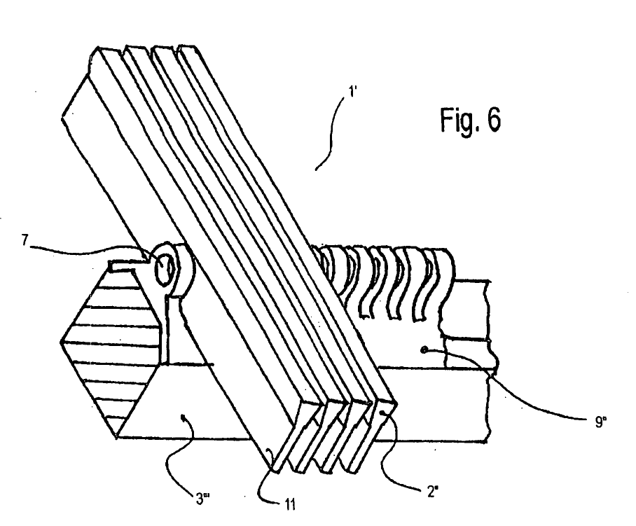

FIG. 6 a perspective partial view of a further embodiment of a screening device according to the invention;

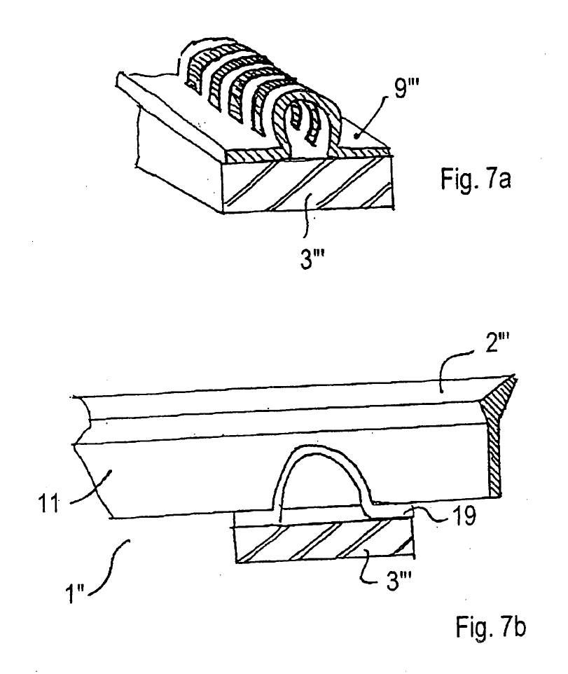

FIGS. 7a and 7b schematic partial views to illustrate further embodiments of a screening device according to the invention.

Same or corresponding elements in the Figures are generally indicated by same reference numerals. Embodiments and modifications thereof as described in the figures are to be understood only as exemplary and in no way as limiting the scope of the invention.

FIG. 1 shows a schematic perspective view of an embodiment of the screening device 1, for use in the treatment of fiber suspension in the paper industry, in particular for sorting. The screening device 1 comprises in longitudinal direction rods 2 extending in parallel direction, whereby for purposes of illustration only a partial view of a rod 2 is shown in FIG. 1. With the aid of a spacer element designated as 4*, which is combined with a connecting element, the parallel rods 2 are spaced form each other, thereby forming screen slots between neighboring rods 2. Furthermore, the slotted screen device 1 comprises several reinforcing elements that are oriented orthogonal to the longitudinal direction of the rods 2 and regularly spaced spacer element 3 for absorbing the static and dynamic stresses of the screening device 1. For a better overview, FIG. 1 only shows a partial view of the reinforcing element 3. The form-fitting and force-fitting connection of rods 2 with the reinforcing elements 3 is realized by means of the connecting element 4, which is spatially disposed in-between. The connecting element 4 positions a protrusion (not seen here) within a complementary recess 5 in the rod bottom area 11, which forms the form-fitting connection between the rods 2 and the connecting elements 4. The structural details of the embodiments for the form-fitting connection are in particular shown in FIGS. 3a and 3b, as well as FIGS. 4a, 4b and 4c and are further described in that context.

The connection of the reinforcing elements 3 with the connecting elements 4 as shown in FIG. 1 is a form-fitting connection, wherein the T-shaped lead of the reinforcing element 3 is positioned within a T-shaped complementary shaped recess in connecting element 4. FIG. 2 shows a sketch of a detail of the screening device according to the invention without the reinforcing element 3, in order to show the complementary configuration of the recess without being obstructed by the reinforcing element 3.

The recesses are not limited to T-shaped configuration; of course, they can have a teardrop shape or can also be polygonal.

In accordance with FIGS. 3a and 3b, various embodiment of connecting elements 4 and 4′ are hereinafter shown and described.

The connecting element 4 in FIG. 3a is shown here as a closer illustration of a single perspective view. The connecting element 4 as shown here is divided into a sector which is facing the area of the rod bottom and a further sector which faces the reinforcing element 3. The section of the rod bottom, in connection with the rod bottom width, forms the spacer function of the connecting element 4. Depending on the desired screen width of the screen device 1, the thickness D of the connecting element 4 can be selected from a variety of different thicknesses or may be realized by machining the front surface 12 of the connecting element 4. FIG. 3a shows a cylindrical tenon configured as a protrusion 8 and disposed in orthogonal position relative to front face 12* and representing a partial element of the form-fitting connection. The spatial orientation of the tenon within the front face 12* is defined as a point of the axis of symmetry of the connecting element 4 and the height H, wherein the height H is defined as the distance between the start of the rod bottom and height level H of the neutral fiber of the weighted rods 2.

The region of the connecting elements 4, which is facing the reinforcing elements 3, has a width B, which is slightly smaller than the distance between two neighboring rods 2. In a further embodiment, the connecting elements 4 can also be configured as members of a chain of connecting elements 9. In that case, the originally single connecting element 4 is arranged evenly spaced and identically oriented on a wire 10 and preferably connected by material union. As a result, the connecting elements 4 are spatially arranged and oriented thereby simplifying the assembly of the connecting elements 4 with the rods 2.

FIG. 3b shows an alternative embodiment of a connecting element 4′. When shifting the T-shaped recess into the reinforcing element 3′, the connecting element 4′ can consequently be made of a uniform thickness D throughout over front faces 12 and 12′. Since this embodiment has no division into sectors of different thicknesses, production of the connecting elements is rendered simpler and more cost-efficient. When forming the chain 9′ of connecting elements, the connecting elements 4′ are likewise uniformly spaced and identically oriented at the T-shaped area of the form-fitting connection and attached to the wire 10′. The connecting element chain 9′ thus has comparably advantageous properties as the embodiment described in FIG. 3a.

FIGS. 4a and 4c show cross sectional illustrations of the various formfitting connections between rod 2 and the connecting element 4 in a slotted screening device according to the invention. FIG. 4a illustrates the afore-described embodiment showing the passage-like hole-shaped recess 5 in rod bottom area 11 of rods 2. In a design complementary to the connecting elements, the cylindrical tenons are configured as protrusions 8 at the front face 12* of the connecting elements 4. The height of the cylindrical tenons 8 is necessarily smaller than the rod bottom of rods 2 so that the space-generating front faces 12 and 12* and the rod bottom areas 11 can rest flatly threreagainst.

FIG. 4b shows a cross section of rod 2′ having a recess 5′, which is formed as a conical counter sink in the area of the rod bottom 11′. This recess 5′ can be realized through a reshaping process. Preferably, the recess 5′ is being formed by a machining production process, for example using a twist drill. The advantage of configuring recess 5′ in this manner is the effect of fewer jags in the recess 5′ and the correspondingly greater life expectancy of the rods 2′. The complementary configuration of the protrusions 8 of the connecting elements 4′ is formed as a blunt cone. In the sectional representation of FIG. 4b, the conical protrusion 8′ is shown as a blunt triangle. Other embodiments of protrusions 8 and 8′ are not shown here in detail and the complementary recesses 5 and 5′ can be configured as disc-shaped, prism-shaped to in other geometric shapes.

FIG. 4c illustrates another variant of a form-fitting connection. Here, the protrusion 6 is now provided in the area of rod bottom 11 of rod 2″. The protrusion 6 can for example be formed by means of reshaping the area of the rod bottom by means of a stamping process. The complementary recess 7 of the connecting element 4′″ is here configured as space-generating ring element, which circumferentially receives the protrusion 6 of rod 2.

FIGS. 5a to 5b show a schematic representation of the form-fitting co-operation between the connecting elements 4 and 4′ and the reinforcing elements 3 and 3′.

FIG. 5a shows the effect of the form-fitting snap connection between the connecting element 4 and one reinforcing element 3 of the slotted screen device according to the invention as in FIG. 1. In the left-hand side illustration, the reinforcing element 3 is positioned below the connecting element 4 in such a manner that the lead of the reinforcing element 13 projects into a T-shaped recess of the connecting element 4. During assembly, the lead of reinforcing element 13 is pressed into the recess, such that the elastically deformable flanks 14 and 15 of the connecting element 4 yield in longitudinal direction of the rods 2. As soon as the lead of the reinforcing element 13 is entirely received within the recess of the connecting lament 4, the flanks 14 and 15 of the connecting element 4 bounce back.

In FIG. 5b, an alternative form-fitting snap connection between the connecting element 4′ and a reinforcing element 3′ is shown.

In that embodiment, the elastic flanks 17 and 18 are formed in the reinforcement element 3′ and provided with the complementary connecting element 4′ with the T-shaped lead 16. The principle of the form-fitting snap-connection is analogous to the embodiment as shown in FIG. 5a.

As shown in FIG. 6, the embodiment of the slotted screen device 1′ is schematically illustrated in a perspective view. A connecting element chain 9′ is utilized having an operating mechanism of the form-fitting connection between the connecting element 4′″ and rod 2″ in accordance with FIG. 4c, which does not comprise single elements but has a comb-like configuration.

The connecting element chain 9″ according to FIG. 6 can be assembled by means of a material union with a pipe, which serves as a receptacle for rods 2, and a tub-shaped flat wire utilized for receiving the connecting elements 3. The pipe-shaped area is prepared in a machining step with slot shaped uniformly spaced recesses corresponding to the width of the rod bottom. The annular shaped recesses 7 of connecting element chain 9″, encloses the protrusions 6 of rods 2″ (not seen here) for a form-fitting connection.

According to a preferred embodiment, the slotted screen device 1′ is configured as slotted screen cylinder. For the uptake of radial forces acting from the screen interior toward the outside, the ring shaped reinforcing elements 3″ are inserted in circumferential direction into the tub-shaped area of the connecting element chain 9″. The tub- or C-shaped receptacle of the connecting element chain 9″ together with the ring-shaped reinforcing element 3″ makes a form-fitting connection, which functions without any snap closure mechanism as shown in FIGS. 5a and 5b. Additionally, by means of the tub-shaped configuration, a directed and flow mechanically efficient draining of the fiber suspensions during operation is realized.

FIGS. 7a and 7b show a further slotted screen device 1″ with a comb-like configuration of the connecting element chain 9′″. As compared to FIG. 6, where a closed pipe-shaped area for receiving the rods 2′″ is used, here, a looped and slotted metal element is used to realize the spacing. This thin-walled metal element is materially interconnected with the rod-shaped reinforcing element 3′″. Subsequently, rods 2′″ which are formed without recesses 5, 5′ or protrusions 6, are inserted into the recess of the looped connecting element chains 9′″. By means of a bending process, whereby the rods are located radially on the inside, the slot-shaped recesses are narrowed by the space-generating web areas. When selecting the suitable material for the metal element, the hardness of the metal element preferably should be higher than the material hardness of the rods, the space-generating web areas will substantially retain their shape at a steady diminishing bending radius, while they become evenly pressed into the rod bottom areas 11 of the rods 2′″ thus forming local recesses and protrusions at the rod bottom areas. The formation of recesses and protrusions at the rods' bottom areas per se form the form-fitting connection of rod 2′″ and the connecting element chain 9′″.

While not shown here in detail, combinations of the afore-described embodiments of connecting elements 4 to 4′″ and various reinforcing elements 3 to 3′″ can be realized in a slotted screening device 1, 1′, 1″, 1′″. The invention is thus not limited to the afore-described and explained details of the slotted screen device 1 to 1″, but numerous changes and modifications are possible which those skilled in the art will know how to carry out and that are within the scope of the invention. Of course the slotted screen device 1, 1′, 1″, 1′″ need not be configured as a level slotted screen mat, but can for example be configured as a slotted screen cylinder or as an arc-shaped curved slotted screen mat.

### Slotted Screen Device

### Reference numeral list

1, 1′, 11′ entire slotted hole screen device
2, 2′, 2″, 2′″ rod
3, 3′, 3″, 3′″ reinforcing element
4, 4′, 4″, 4′″, connecting element
4*, 4*′, 4*″, 4*′″ distancing element
5, 5′ recess of the rod
6 protrusion of the rod
7 recess of the connecting element
8, 8′, 8″ Protrusion of the connecting element
9, 9′, 9″, 9′″ connecting element chain
10 wire
11 rod bottom area
12 front face of the connecting element
13 lead of the reinforcing element
14, 15 snap-closure of the connecting element
16 lead of the connecting element
17, 18 snap-closure of the reinforcing element
D spacer-generating thickness of the connecting element 4, 4′, 4″, 4′″
B width
H height level of the neutral fiber of the rod 2, 2′, 2″, 2′″

1-11. (canceled)

12. A slotted screen device for the treatment of fiber suspensions in the paper industry, which comprises:
a plurality of fixed rods extending in parallel direction and mutually spaced at a pre-determined distance, and
a spacer assembly including one or more spacer elements and at least one connecting element, and
at least one reinforcing element connected to the spacer assembly;
wherein the spacer elements are associated with the rods for maintaining a slot width for the screen device and wherein the rods are fixed in three-dimensional directions in form-fitting manner by the spacer assembly such that the rods are spaced in direction close to a neutral zone of the rods under stress, which stress is transmitted to the reinforcing elements.

13. The slotted screen device according to claim 12, wherein the connecting elements forms a form-fitting connection with the reinforcing elements in orthogonal direction to a longitudinal dimension of the rods.

14. The slotted screen device according to claim 12, wherein each of a pre-determined variable slot width is established in dependence on the width of the rod bottom area and the connecting elements.

15. The slotted screen device according to claim 12, wherein the rods are provided with one of recesses or protrusions and wherein the connecting elements are configured with complementary shaped recesses or protrusions at a front surface of the connecting elements that is facing the rods for forming the form-fitting connection of the rod bottom area.

16. The slotted screen device according to claim 15, wherein the outer contour of connecting element is configured in a flow-efficient shape.

17. The slotted screen device according to claim 15, wherein the front face of the connecting element facing the reinforcing element, is conformed to a profile of the reinforcing element without transition.

18. The slotted screen device according to claim 12, wherein the slotted screen device is configured as a rotation-symmetrical screen cylinder and the reinforcing element is configured as a reinforcing ring for absorbing radial stress.

19. The slotted screen device according to claim 12, wherein the connecting elements are configured in the shape of a unitary connecting element chain, which comprises one or more connecting elements.

20. The slotted screen device according to claim 19, wherein one of the connecting elements or the connecting element chain is connected to at least one reinforcing element.

21. The slotted screen device according to claim 20, wherein the form-fitting connection is configured as a snap-connection.

22. The slotted screen device according to claim 12, wherein each spacer element is firmly connected with each of the corresponding reinforcing elements and wherein the connecting elements that are in form-fitting connection with the rods are fully formed when the fixed spacer elements that are connected with the respective reinforcing element are suitably bent.

23. A slotted screen device for the treatment of fiber suspensions in the paper industry, which comprises:
a plurality of fixed parallel extending rods, said rods are spaced from each other to establish a slot width for the screen device;
one or more spacer elements arranged at the rods for spacing the rods at a pre-determined distance, said spacer elements are also configured as connecting elements; and
at least one reinforcing element; wherein the spacer elements are bearing flat at corresponding bottom flanks of the rods and are spaced from a rod bottom area in direction to an unstressed zone of the rod under stress for fixing the rods in three-dimensional directions in form-fitting manner, and wherein the stress from the rods are transmitted to the reinforcing elements.

24. A slotted screen device for the treatment of fiber suspensions in the paper industry, which comprises:
a plurality of fixed rods extending in parallel direction and spaced at a pre-determined distance, and
one or more spacer elements associated with the rods for establishing a slot width for the screen device, and
at least one reinforcing element, and
wherein the spacer elements are configured as connecting elements for fixing the rods in three-dimensional directions in such form-fitting manner so that the rods are spaced in direction close to a neutral zone of the rods under stress, whereby a force is transmitted to the reinforcing element.

25. The slotted screen device according to claim 12, wherein each of a pre-determined variable slot width is determined through the cooperation between the rods and the connecting elements.
